(19) United States
(12) Patent Application Publication
(10) Pub. No.: US 2008/0001760 A1
(43) Pub. Date: Jan. 3, 2008

(54) RFID Antenna System For A Storage Shelf

(75) Inventors: Cheng Guan Michael OH, Singapore (SG); Boon Wee Quek, Singapore (SG); Lee Ying Ng, Singapore (SG); Chee Sheng Chua, Singapore (SG); Ye Gu, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: TCM RFID Pte Ltd, Singapore (SG)

(21) Appl. No.: 11/768,929

(22) Filed: Jun. 27, 2007

Related U.S. Application Data
(60) Provisional application No. 60/805,877, filed on Jun. 27, 2006.

(51) Int. Cl. G08B 13/14

(52) U.S. Cl. 340/572.7

(57) ABSTRACT

The present invention provides a storage shelf (312,314,316) in a RFID tracking system (100). In one embodiment, the storage shelf (312,314,316) is on a medical supply trolley (300). Each storage shelf (312,314,316) has two RFID antennae (340a, 340b) that are aligned substantially orthogonal to each other. Each RFID antenna (340) is tuned to a resonant frequency, and with a bandwidth below and above the resonant frequency. The bandwidth defines a Q factor such that the antenna (340) is insensitive to a conductor placed near the antenna (340).

### FIELD OF INVENTION

The present invention relates to a RFID antenna system. In particular, the invention relates to a RFID antenna system for use in a medical supplies storage shelf forming part of the medicine trolley equipped with a RFID reader for monitoring the dispensing of medicine and medical supplies in a health care institution.

### BACKGROUND

The invention disclosure in a co-pending application No. 60/805,873 filed on 27 Jun. 2006 is incorporated in its entirety. The reference numerals used in co-pending application No. 60/805,873 are also used in the present application.

Attempts have been made to ensure medical safety in hospitals and other health care institutions. For example, US patent publication 2006/0043179 discloses a smart surgical instrument tray equipped with RFID reader. The contents on the tray is monitored and tracked, and both the instruments' and tray's life cycle usage is monitored.

To reduce human error in the administration of medicine is still a challenge. This is because many health care personnel are involved. Ideally, the responsibility of each personnel in administering each medication must be monitored and tracked. If an abuse is detected, the hospital system should be able to alert to a health care staff immediately.

It can thus be seen that there exists a need for a system that can actively monitor and trace the dispensing of medicines in any health care institution.

### BRIEF DESCRIPTION OF THE DRAWINGS

This invention will be described by way of non-limiting embodiments of the present invention, with reference to the accompanying drawings, in which:

FIG. 1 illustrates a pair of RFID antennae in accordance with an embodiment of the present invention;

FIG. 2 illustrates a construction of an RFID antenna as shown in FIG. 1;

FIG. 3 illustrates a resonance frequency characteristic of the RFID antenna shown in FIG. 1;

FIG. 4A illustrates an arrangement of the antenna shown in FIG. 1 with interrogating radio wave fluxes covering the inside of a medicine drawer; and

FIGS. 4B and 4C illustrate alternative arrangements of the antennae shown in FIG. 1.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the invention. For ease of reference, common reference numerals or series of numerals will be used throughout the figures when referring to the same or similar features common to the figures.

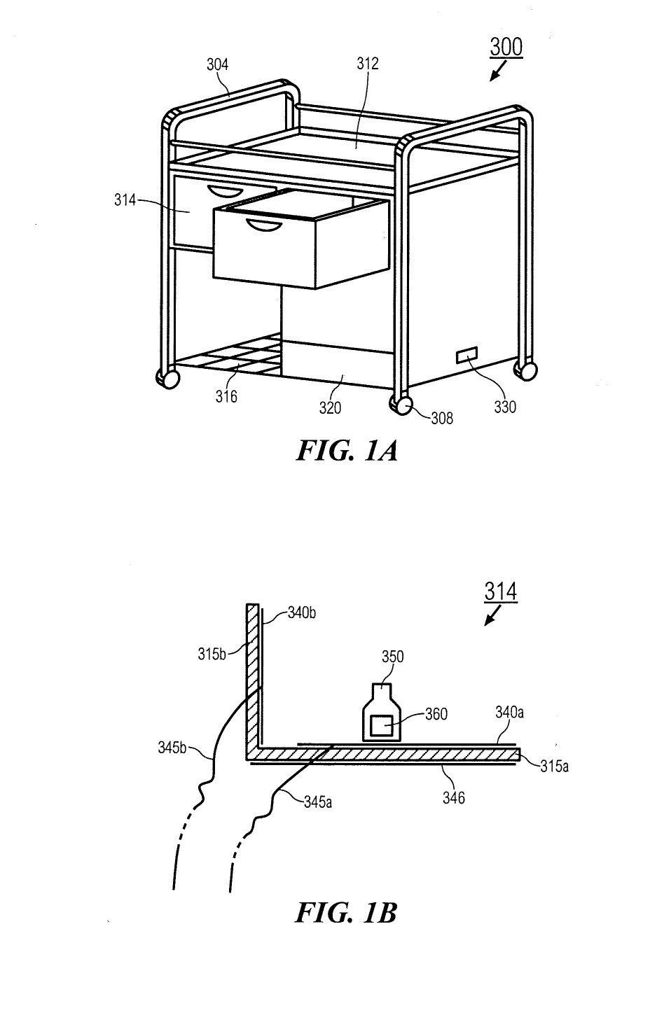

FIG. 1A shows a medicine trolley 300 according to an embodiment of the present invention. FIG. 1B shows a cross-section of a medicine drawer 314 of the medicine trolley shown in FIG. 1A. As disclosed in co-pending application No. 60/805,873, the medicine trolley 300 is stocked with medical drugs and supplies 350, for example by a pharmacist 224, and is operable in a RFID tracking system 100. All the medical records in the hospital, including doctors' prescriptions, pharmacists' drugs dispensed and the nurses' administration of the drugs to patients, are stored in a central database 108.

Also as disclosed in the co-pending application and as shown in FIG. 1B, each medicine drawer 314 is equipped with a pair of orthogonal antennae 340a, 340b. One antenna 340a is disposed on or in the base 315a of the drawer and the other antenna 340b is disposed on or in a vertical sidewall 315b. Each antenna 340a, 340b is connected via a co-axial cable 345a, 345b to a RFID reader 324.

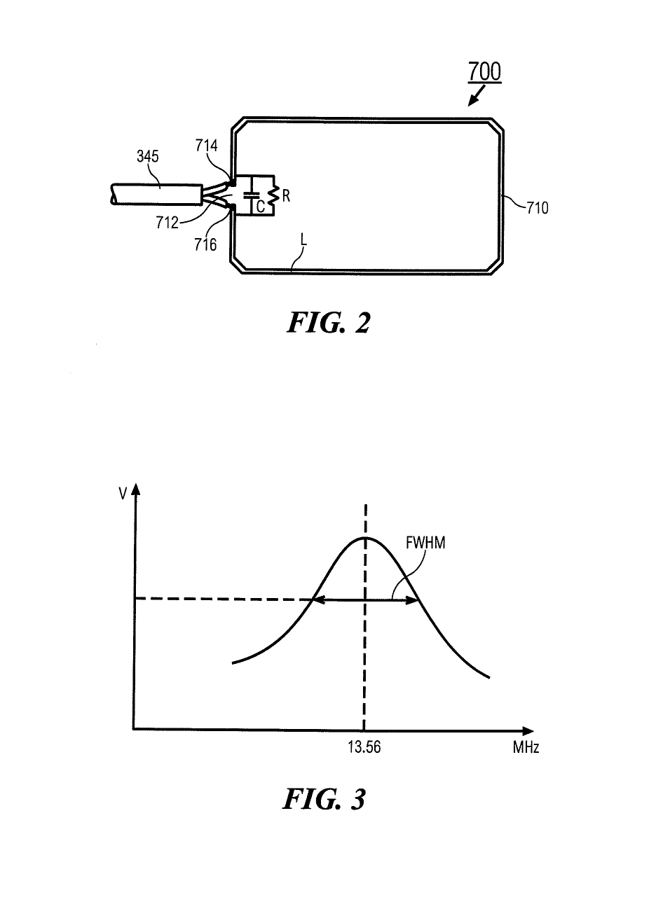

FIG. 2 shows an antenna 340 according to an embodiment of the present invention. As shown in FIG. 2, each antenna 340 has a conductor 710 formed in an open loop with the ends 714, 716 separated by a gap 712. A capacitor C and a resistor R are connected across the gap 712. In addition, a core of the co-axial cable 345 is removed of its insulation and connected to one end 714 of the conductor 710 while the shield is connected to the other end 716 of the conductor. The conductor 710 formed in a loop behaves like an inductor and has an inductance L. In another embodiment, the core of the co-axial cable 345 is connected to the end 716 of the conductor 710 whilst the shield is connected to the other end 714 of the conductor.

The antenna 340 for use with the present invention is tuned with a Standing Wave Ratio (SWR) meter by selecting the R and C parameters for a given L parameter of the conductor 710 loop and length of the co-axial cable 345. In one embodiment of the antenna, the antenna 340 is tuned to a resonant frequency of 13.56 MHz and a bandwidth of −1 and +1 MHz about the resonant frequency at the full wave half maximum (FWHM) point. This bandwidth also defines the quality factor Q of the frequency response of the antenna 340. At this bandwidth or Q factor, the antenna 340 is made insensitive to any conductor that may be near to the medicine trolley 300, such as, a frame of the trolley 300 itself.

In another embodiment of the antenna 340, the conductor 710 is made up of a plurality of copper loops etched on a laminated board with the ends forming a gap 712 and the ends 714, 716 connected to the co-axial cable 345. In another embodiment, the antenna 340 is moulded in with conductor loop 710 sized and dimensioned to overlay on the inside board, i.e. base or sidewall, of the medicine drawer 314. In yet another embodiment, the antenna 340 is molded to form an integral part of the base or side wall/board of the medicine drawer 314.

In addition to the above embodiments, the lower side of each medicine drawer 314 has an electromagnetic shield 346. The electromagnetic (EM) shield 346 on each medicine drawer 314 and that above it both help to confine the interrogating radio waves emitted by each antenna 340 to within each medicine drawer 314. This is to minimize detecting the RFID tags on medicine containers stored outside of each drawer 314. In an embodiment of the EM shield, the EM shield 346 is attached to the bottom or outboard side of each medicine drawer 314. In another embodiment, the EM shield 346 is located below the antenna 340 inside or inboard the medicine drawer 314. In yet another embodiment, the EM shield is moulded into the base 315a board or side 315b board of the medicine drawer 314. In one embodiment of the EM shield, the EM shield 346 is an aluminium foil. In another embodiment, the EM shield 346 is a conductor foil. The EM shield may shield off the electric field component of the radio waves emitted by the antennae 340 yet without changing the magnetic component of the radio waves. In another embodiment of the present invention, the medical supply storage area includes the open-top tray 312 and/or the open-shelf 316 in addition to the drawer 314.

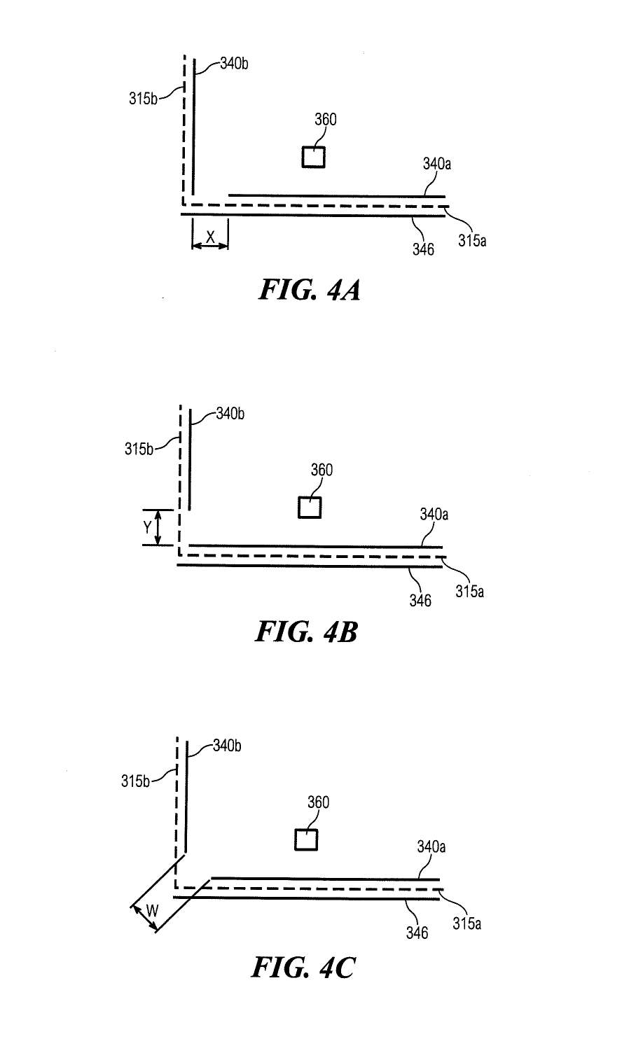

FIGS. 4A-4C illustrate the relative arrangement of the two orthogonal antennae 340a,340b. As can be seen in FIGS. 4A-4C, the conductor 710 loops of the antennae 340 are located so that they are spaced apart by a horizontal distance X, a vertical distance Y or an angular distance W. Each distance X, Y is substantially about 5 cm or more. Angular distance W in FIG. 4C is substantially about 6 cm or more. The distance X, Y or W is to minimize “collision” of the interrogating radio waves emitted from the antennae 340a,340b in each medicine drawer 314. By arranging a pair of antennae 340a,340b orthogonally to each other, the EM radio waves are made to radiate at some angles to the respective antenna 340 so that the interrogating radio fluxes pass through the RFID tags 360 on the medicine container 350. A standalone antenna would generate interrogating radio waves that radiate perpendicularly to the antenna; the fluxes passing through a plane of a RFID tag attached on a vertical wall of a medicine container would accordingly be minimal and the rate of failure to detect the RFID tag is then high. By arranging the orthogonal antennae 340a,340b in accordance with the present invention, the detection rate of RFID tags on medical supplies 350 placed in the storage area 312,314,316 of the medicine trolley 300 is very high, and it was found to reach 99% or more. In one embodiment of the present invention, each RFID antenna 340 scans RFID tags 360 three times during each interrogation so that detection rate is even higher.

In another embodiment of the medicine drawer, the pair of antennae 340 forms two separate sides 315b of the medicine drawer 314.

While specific embodiments have been described and illustrated, it is understood that many changes, modifications, variations and combinations thereof could be made to the present invention without departing from the scope of the invention. For example, the pair of antennae 340 may not be orthogonal to each other, so long as they are not parallel to each other. The plane of the antenna may just take the plane of the base or sidewall of the medicine drawer. In addition, the present invention is not confined to monitoring and tracking of medical supplies; other items, for example, goods on a storage compartment, such as, a shelf of a warehouse may be monitored and its content or stock is updated automatically and regularly in a database.

1. A storage compartment in an RFID tracking system, said storage compartment comprising two RFID antennae that are aligned substantially orthogonal to each other.

2. A storage compartment according to claim 1, wherein one of the RFID antennae is aligned in a horizontal plane in the storage compartment and the other is aligned in a side thereto.

3. A storage compartment according to claim 1, wherein the RFID antennae are aligned in adjacent sides with respect to a horizontal plane in the storage compartment.

4. A storage compartment according to any one of claims 1-3, wherein each antenna is tuned with a standing wave meter to a resonant frequency of 13.56 MHz and a quality factor of −1 and +1 MHz about the resonant frequency.

5. A storage compartment according to claim 4, wherein each antenna is tuned by varying a combination of these factors: capacitance C, resistance R, inductance L and length of cable.

6. A storage compartment according to any one of claims 1-5, wherein the antennae are spaced apart by a horizontal distance X, a vertical distance Y or an angular distance W.

7. A storage compartment according to claim 6, wherein the distance X or Y is substantially 5 cm or more and the angular distance W is substantially 6 cm or more.

8. A storage compartment according to any one of claims 1-7, further comprising an electromagnetic (EM) shield separating a compartment from an adjacent compartment.

9. A storage compartment according to claim 8, wherein the EM shield is disposed outboard, inboard or integrally within a board of the compartment.

10. A storage compartment according to claim 8 or 9, wherein the EM shield is an aluminium foil.

11. A storage compartment according to any one of claims 1-10, wherein the storage compartment is on a trolley.

12. A RFID tracking system comprising:
a trolley having a storage compartment, said storage compartment has two RFID antennae that are aligned substantially orthogonal to each other.

13. A system according to claim 12, further comprising a RFID controller, a RFID reader and a wireless communication unit to communicate with a database.

14. A system according to claim 12 or 13, wherein the RFID controller controls each RFID antenna to scan RFID tags during each interrogation.

15. A system according to claim 14, wherein each interrogation comprises a plurality of scans.
